(19) United States
(12) Patent Application Publication
(10) Pub. No.: US 2017/0336647 A1
(43) Pub. Date: Nov. 23, 2017

(54) REPLACEMENT STRUCTURE OF EYEGLASSES LENS

(71) Applicant: PROHERO GROUP CO., LTD., TAINAN CITY (TW)

(72) Inventor: PEN-WEI CHEN, TAINAN CITY (TW)

(21) Appl. No.: 15/160,163

(22) Filed: May 20, 2016

(51) Int. Cl. G02C 1/06

(52) U.S. Cl. CPC G02C 1/06

(57) ABSTRACT

A replacement structure of eyeglasses lens is disclosed. A frame comprises two circular openings corresponding to each other, at least one recess at the periphery of each circular opening, and a sliding slot connected with the recess. A lens rim is around the lens periphery, wherein the rim shape is circular to correspond to the circular opening for assembling the rim in the circular opening, and a projection is protruded from the rim periphery to correspond to the recess and embedded in the recess. When the rim is rotated, the projection is moved into the sliding slot to fasten the lens. Accordingly, the assembly and disassembly of the lens with the frame does not require any tools, being simpler, easier, and faster. Furthermore, the different color and style of the rim is used to match with the frame, so the use is richer and more is varied to attract consumers' attention.

### BACKGROUND OF THE INVENTION

### Field of the Invention

The present invention relates to a replacement structure of eyeglasses lens. More particularly, the replacement structure of eyeglasses lens is not only that the assembly and disassembly procedure of the lens with the frame does not require tools, so the procedure is simpler, easier, and faster, but also that the different color and style of the rim is used to match with the frame, so the use is richer and more varied to attract the consumer's attention, which the replacement structure of eyeglasses lens has more product competitiveness and is increased in practical characteristic.

### Description of Related Art

The general glasses are divided into optical glasses, sunglasses, sport spectacles, and safety glasses, according to their uses and function. The frame design of different type of the glasses is different. For example, in the full-rim glasses, the lens is all received in the frame to protect the safety of the lens, so the full-rim glasses are used in optical glasses with expensive lens. However, the half-rim glasses is lighter than the full-rim glasses, so it is used in sunglasses, sports spectacles, and safety glasses, which emphasis in light weight and well-executed, for user doing sport, outside exercise, or construction.

Whatever the glasses is applied for, the basic structure of the glasses comprises the lens assembled with the frame. The lens is assembled with the assembly hole of the frame and fixed in the screw hole in the assembly hole of the frame by the screws, so the lens is held between the assembly holes of the frame. Then, the temples are pivoted with the two sides of the frame to complete the assembly of the glasses.

The lens of the foregoing glasses is fixed between the assembly holes of the frame by screws; however, in the actual use, it requires the tools for assembling the lens with the frame or separating the lens from the assembly holes. It is inconvenient to assemble or separate the lens, if the user does not have the proper tool in hands, it results that the lens cannot be assembled with or separated from the frame.

### SUMMARY OF THE INVENTION

Accordingly, the object of the present invention is related to a replacement structure of eyeglasses lens. In which, not only that the assembly and disassembly procedure of the lens with the frame does not need the tools, so the procedure is simpler, easier, and faster, but also that the different color and style of the lens rim is used to match with the frame, so the use is richer and more varied to attract the consumer's attention. The replacement structure of eyeglasses lens has more product competitiveness and is increased in practical characteristic.

For the above object, a replacement structure of eyeglasses lens comprises a frame and a lens. The frame comprises two circular openings corresponding to each other, at least one recess at the periphery of each circular opening, and a sliding slot connected with the recess. A lens rim is firmly around the periphery of the lens, wherein the shape of the lens rim is circular to correspond to the circular opening for assembling the lens rim in the circular opening, and a projection is protruded from the periphery of the lens rim to correspond to the recess at the periphery of the circular opening and embedded in the recess. When the lens rim is rotated, the projection is moved into the sliding slot to fasten the lens.

### BRIEF DESCRIPTION OF THE DRAWINGS

FIG. 1 is an exploded perspective view of a replacement structure for eyeglasses lens according to an embodiment of the present invention;

FIG. 2 is a schematic diagram of a replacement structure for eyeglasses lens when it is assembled according to an embodiment of the present invention;

FIG. 3 is a schematic diagram of a replacement structure for eyeglasses lens after it is assembled according to an embodiment of the present invention; and

FIG. 4 is a sectional view of a replacement structure for eyeglasses lens after it is assembled according to an embodiment of the present invention.

### DETAILED DESCRIPTION OF THE PREFERRED EMBODIMENT

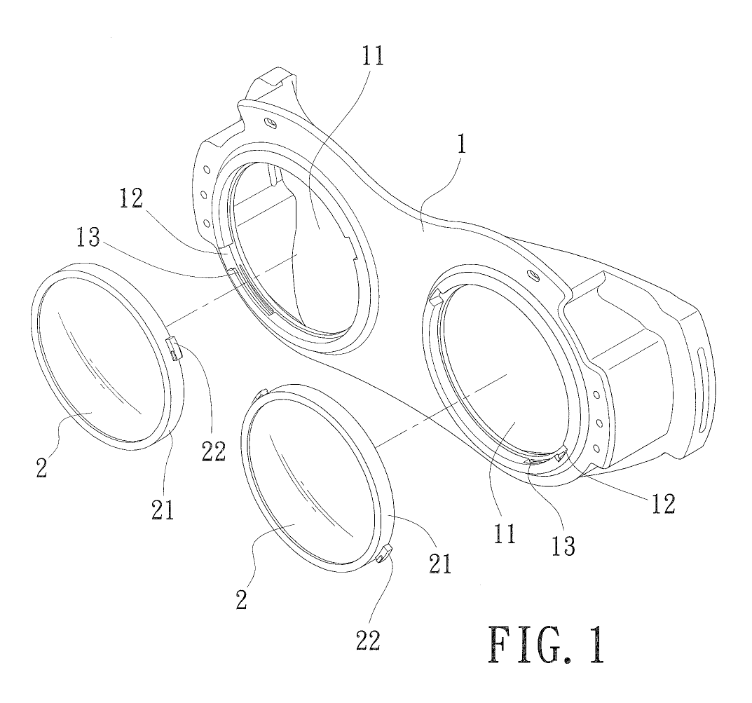

Please refer to FIG. 1, which is an exploded perspective view of a replacement structure for eyeglasses lens according to an embodiment of the present invention. The replacement structure for eyeglasses lens comprises a frame 1 and two lenses 2.

The frame 1 comprises two circular openings 11 corresponding to is each other, at least one recess 12 at the periphery of each circular opening 11, and a sliding slot 13 connected with the recess 12.

A lens rim 21 is firmly around the periphery of each lens 2, wherein the shape of the lens rim 21 is circular to correspond to the circular opening 11 of the frame 1 for assembling the lens rim 21 in the circular opening 11. A projection 22 is protruded from the periphery of the lens rim 21 to correspond to the recess 12 at the periphery of the circular opening 11.

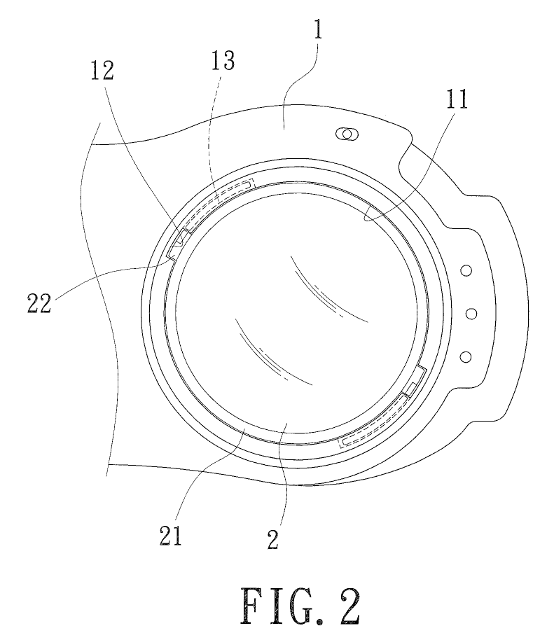

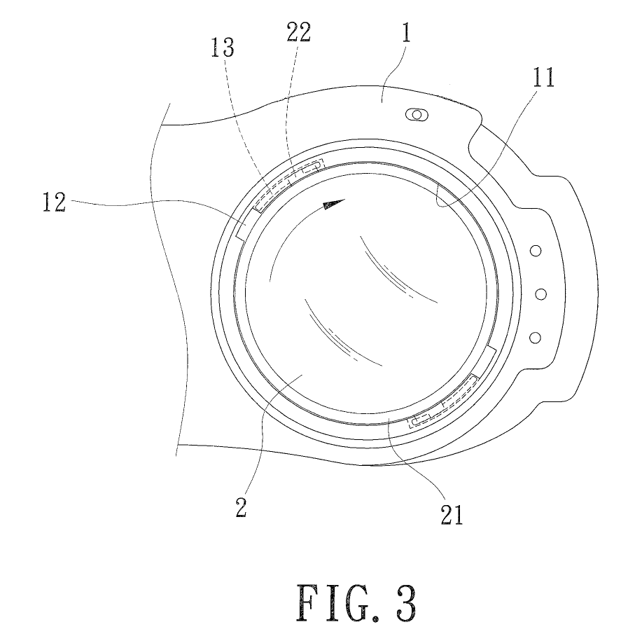

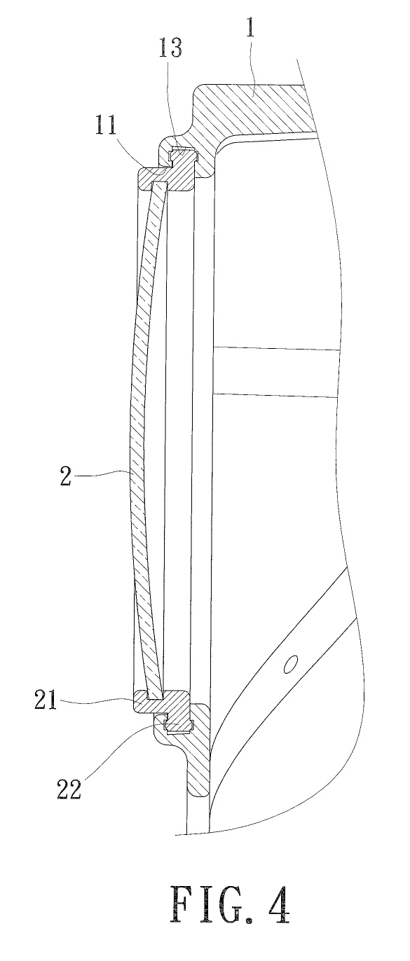

Please also refer to FIG. 2, which is a schematic diagram of a replacement structure for eyeglasses lens when it is assembled according to an embodiment of the present invention. When the replacement structure of eyeglasses lens of the present invention is assembled, the lens rim 21, which is firmly around the periphery of each lens 2, is corresponded to the circular opening 11 of the frame 1, and the projection 22 at the periphery of the lens rim 21 is corresponded to the recess 12 at the periphery of the circular opening 11, then, the lens rim 21 is assembled in the circular opening 11 and the projection 22 is embedded into the recess 12. Next, the lens rim 21 is rotated toward the sliding slot 13, which is connected to the recess 12, so the projection 22 is moved into the sliding slot 13 to embed the projection 22 to the sliding slot 13, please refer to FIG. 3, which is a schematic diagram of a replacement structure for eyeglasses lens after it is assembled according to an embodiment of the present invention, and then, the lens rim 21 together with the lens 2 is assembled in the circular opening 11 of the frame 1, please refer to FIG. 4, which is a schematic diagram of a replacement structure for eyeglasses lens after it is assembled according to an embodiment of the present invention.

Accordingly, the lens 2 with the lens rim 21 is not only directly rotated to be assembled in the circular opening 11 of the frame 1, when the lens is replaced, the lens 2 with the lens rim 21 is also directly rotated to drive the projection 22 move toward the recess 12, making the projection 22 separate from the recess 12 to take out the lens 2 together with the lens rim 21 from the circular opening 11 of the frame 1, whereby the lens 2 is replaced.

According to the above description and embodiments, comparison with the prior art, the replacement structure of eyeglasses lens of the present invention has the advantages as following:

1. The lens with the lens rim of the present invention are rotated in the circular opening of the frame to assemble the lens with the lens rim in the circular opening or to separate from the circular opening, so it does not require the tools during the assembly or disassembly of the lens and the frame, making the procedure of assembling or disassembling the lens and the frame simpler, easier, and faster.

2. Because the outer edge of the lens has the lens rim, the different color and style of the lens rim is used to match with the frame, making is the use richer and more varied to attract the consumer's attention, the replacement structure of eyeglasses lens has more product competitiveness.

1. A replacement structure of eyeglasses lenses, comprising:
a frame including:
a pair of inner wall portions respectively defining two circular openings, corresponding to each other;
at least one recess formed in each inner wall portion at a periphery of each circular opening; and
a sliding slot formed into each inner wall portion to communicate with the recess and extend therefrom about a portion of the circular opening thereof; and
a lens having:
a lens rim disposed firmly around a periphery of the lens, wherein the shape of the lens rim is circular to correspond to one of the circular openings of the frame for assembling the lens therein; and
a projection protruded from the lens rim to correspond to the recess at the periphery of the circular opening and embedded in the recess when the lens is seated in place within the circular opening and engaging one of the inner wall portions of the frame, wherein when the lens rim is rotated while seated in place within the circular opening, the projection is moved from the recess into the sliding slot to fasten the lens.

2. A replacement structure of an eyeglasses lens, comprising:
a frame including:
an inner wall portion defining a rounded opening;
at least one recess formed in the inner wall portion at a periphery of the rounded opening; and
a sliding slot formed into the inner wall portion to communicate with the recess and extend therefrom about a portion of the rounded opening; and
a lens having a lens rim disposed firmly thereabout, wherein the lens rim corresponds in shape to the rounded opening of the frame for assembly therein;
a projection protruded from the lens rim to correspond to the recess at the periphery of the rounded opening, the projection engaging the recess when the lens is seated in place within the rounded opening and engaging the inner wall portion of the frame, wherein when the lens rim is rotated while seated in place within the rounded opening, the projection is moved from the recess into the sliding slot to fasten the lens to the frame.
